(19) United States
(12) Patent Application Publication
(10) Pub. No.: US 2021/0185994 A1
(43) Pub. Date: Jun. 24, 2021

(54) BAIT STORAGE DEVICE

(71) Applicant: Donald Jordan, Putnam, CT (US)

(72) Inventor: Donald Jordan, Putnam, CT (US)

(21) Appl. No.: 16/719,834

(22) Filed: Dec. 18, 2019

(51) Int. Cl. A01K 97/04

(52) U.S. Cl. CPC A01K 97/04

(57) ABSTRACT

An illustrated view of an exemplary bait storage device for transporting and storing bait scent products and power bait. The bait storage device is useful for providing an effective mean of storing and transporting fishing bait, such as pre-packaged bait scent products, power baits, etc. Also, the bait storage device provides improved organization and convenience by ensuring that baits are readily accessible when needed and/or wanted. The bait storage device is also transportable.

### FIELD OF THE INVENTION

This invention relates to fishing bait. More particularly, it relates to storage devices for fishing bait.

### BACKGROUND

Fishing tackle boxes have for many years been an essential part of the angler's equipment. Fishing tackle boxes were originally made of wood or wicker and eventually some metal fishing tackle boxes were manufactured. The first plastic fishing tackle boxes were manufactured by Plano in response to the need for a product that didn't rust. Early plastic fishing tackle boxes were similar to tool boxes but soon evolved into the hip roof cantilever tackle boxes with numerous small trays for small tackle. These types of tackle boxes are still available today but they have the disadvantage that small tackle gets mixed up. Fishing tackle boxes have also been manufactured so the drawers themselves become small storage boxes, each with their own lids. This prevents small tackle from mixing, and can turn each drawer into a stand-alone container which can be used to carry small tackle to a rod some distance from the main tackle box.

There are two types of baits: natural baits and artificial baits.

The natural bait angler usually uses a common prey species of the fish as an attractant. The natural bait used may be alive or dead. Common natural baits include bait fish, worms, leeches, minnows, frogs, salamanders, nightcrawlers and other insects. Natural baits are effective due to the lifelike texture, odors and color of the bait presented.

The common earthworm is a universal bait for fresh water angling. In the quest for quality worms, some fishers culture their own worm compost or practice worm charming. Grubs and maggots are also considered excellent bait when trout fishing. Grasshoppers, flies, bees and even ants are also used as bait for trout in their season, although many anglers believe that trout or salmon roe is superior to any other bait. Studies show that natural baits like croaker and shrimp are more recognized by the fish and are more readily accepted. A good bait for red drum is menhaden. Because of the risk of transmitting whirling disease, trout and salmon should not be used as bait.

Processed baits, such as ground bait and boilies, can work well with coarse fish, such as carp. For example, in lakes in southern climates such as Florida, fish such as bream will take bread bait. Bread bait is a small amount of bread, often moistened by saliva, balled up to a small size that is bite size to small fish.

Artificial baits include lures and other man-made devices. Many people prefer to fish solely with lures, which are artificial baits designed to entice fish to strike. The artificial bait angler uses a man-made lure that may or may not represent prey. The lure may require a specialized presentation to impart an enticing action as, for example, in fly fishing. Recently, electronic lures have been developed to attract fish. Anglers have also begun using plastic bait. A common way to fish a soft plastic worm is the Texas rig.

Known as gulp baits, they are said to be as good as, or better than, the live bait scents they imitate. Those who fish on the coast for flounder, sea trout and red fish swear by them. Even though fish are attracted to certain odors, they are also repelled by others.

Power baits are made of polyvinyl chloride (PVC), the same material used to make pipes and other items. To make a soft plastic bait out of PVC, the material must be heated up and combined with an oil-based resin. The more oil-based resin added to the PVC, the softer the bait will be. This allows for much more scent distribution than with oil-based resins. Because oil and water do not mix, when scent is added to a bait created from PVC and an oil-based resin, the oil literally traps the scent inside the bait. While some of the scent does get out, the oil is actually functioning as a barrier.

There are many devices on the market today that can hold fishing tackle, but there are no specific devices to hold bait, whether natural or artificial. There further are no devices that store, organize and transport prepackaged bait scent products or powder baits in jars.

In light of the foregoing, it would be desirable to devise a bait storage device that provided more flexibility in storing, organizing and transporting of prepackaged bait scent products or powder baits in jars.

### BRIEF DESCRIPTION OF THE DRAWINGS

FIG. 1A is an illustrated side view of an exemplary bait storage device.

FIG. 1B is an illustrated top view of the bait storage device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

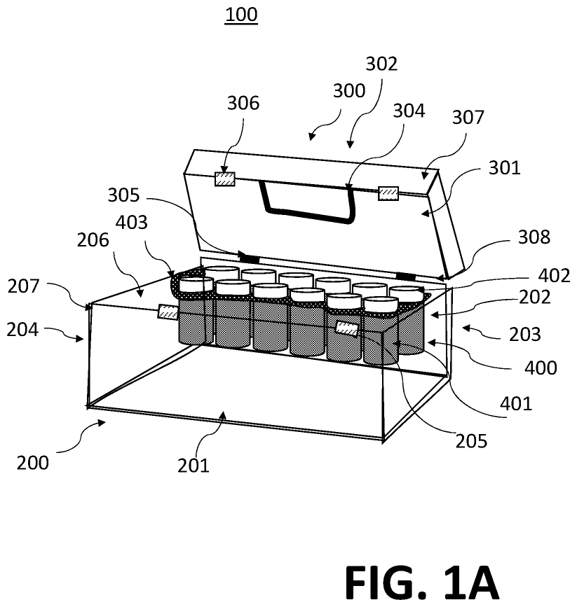

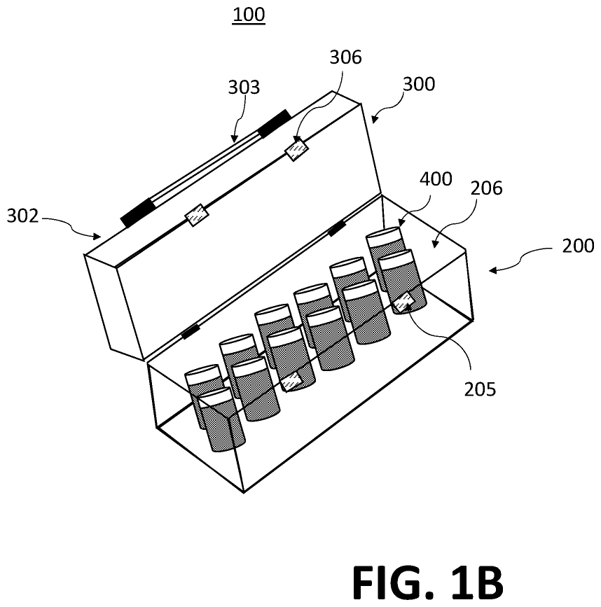

Referring to FIG. 1A and FIG. 1B, an illustrated view of an exemplary bait storage device 100 for transporting and storing bait scent products and power bait. The bait storage device 100 is useful for providing an effective mean of storing and transporting fishing bait, such as pre-packaged bait scent products, power baits, etc. Also, the bait storage device 100 provides improved organization and convenience by ensuring that baits are readily accessible when needed and/or wanted. The bait storage device 100 is also transportable.

The bait storage device 100 preferably has a length of twenty (20) inches, however other lengths are hereby contemplated, including, but not limited to, eighteen (18) inches, twenty-three (23) inches, etc. The bait storage device 100 preferably has a width of four (4) inches, however other widths are hereby contemplated, including, but not limited to, three (3) inches, five (5) inches, etc. The bait storage device 100 preferably has a height of six (6) inches, however other heights are hereby contemplated, including, but not limited to, four (4) inches, ten (10) inches, etc. The bait storage device 100 is preferably made of a plastic material, however other materials are hereby contemplated, including, but not limited to, poly-vinyl chloride (PVC), aluminum, etc.

The bait storage device 100 has a box 200, a top 300 and a plurality of containers 400.

The box 200 of the bait storage device 100 has a first side 201, a second side 202, a third side 203, a fourth side 204, one or more receiving latches 205 and an inside 206. The inside 206 of the box 200 of the bait storage device 100 is preferably hollow. The one or more receiving latches 205 are preferably made of a plastic material, however other materials are hereby contemplated, including, but not limited to, rubber, poly-vinyl chloride (PVC), etc. The one or more receiving latches 205 are preferably female receiving latches. The one or more receiving latches 205 are preferably securely coupled to a top 207 of the first side 201 of the box 200 of the bait storage device 100. The one or more receiving latches 205 are preferably equal distance from the second side 202 and the fourth side 204 of the box 200.

The plurality of containers 400 have a body 401 and a top 402. The top 402 of the containers 400 are configured to securely couple to the body 401 of the containers 400 using a screwing means. The top 402 of the container 400 is configured to screw a groove onto a grove of the body 401 of the containers 400. The plurality of containers preferably contain power bait or bait products.

The plurality of containers 400 are securely coupled by a panel 403. The panel 403 preferably has six (6) holes 404, where the body 401 of the containers 400 are pushed through each of the holes 404 and the top 402 is then coupled to the body 401 of the containers 400 by the screwing means.

The top 300 of the bait storage device 100 has an inside 301, a top side 302 (see FIG. 1B), a handle 303 (see FIG. 1B), a support stand 304, one or more hinges 305 and one or more coupling latches 306.

The one or more coupling latches 306 are coupled to a front 307 of the top 300 and are configured to be securely and removably coupled to the receiving latches 205 of the box 200. The one or more coupling latches 306 are preferably made of a plastic material, however other materials are hereby contemplated, including, but not limited to, rubber, poly-vinyl chloride (PVC), etc. The one or more coupling latches 306 are preferably male coupling latches.

The one or more hinges 305 are coupled to a back 308 of the top 300 and further securely coupled to a top 208 of the fourth side 204 of the box 200.

The support stand 304 is coupled to the inside 301 of the top 300. The support stand 304 is useful in providing a mechanism to keep the top 300 in an open position while the containers 400 stored on the inside 206 of the box 200 are being accessed.

The handle 303 is coupled to the top side 302 of the top 300. The handle 303 is useful for providing a carrying device for transporting the bait storage device 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bait storage device for containing power bait and bait products, the device comprising:
a box, the box having a first side, a second side, a third side, a fourth side and an inside;
a plurality of containers, the containers having a top and a bottom, wherein the top is coupled to the bottom by a screw mechanism;
a panel, the panel being configured to have a plurality of holes, wherein the bottom of the containers being configured to be inserted into the holes, wherein the top is coupled to the bottom by the screwing mechanism;
one or more receiving latches, the latches being coupled to a top of the first side of the box;
a top, the top having a top side, an inside and a back;
one or more hinges, the hinges being coupled to the back of the top and wherein the hinges further being coupled to a top of the fourth side of the box;
a support stand, the support stand being coupled to the inside of the top;
one or more coupling latches, wherein the coupling latches being securely and removably coupled to the receiving latches to secure the top to the box; and
a handle, the handle being coupled to the top side of the top.

2. The device of claim 1, wherein the device having a length being twenty (20) inches.

3. The device of claim 1, wherein the device having a width being four (4) inches.

4. The device of claim 1, wherein the device having a height being six (6) inches.

5. The device of claim 1, wherein the device having a shape being rectangular.

6. The device of claim 1, wherein the device being made of a plastic material.

7. The device of claim 1, wherein the receiving latches being made of a plastic material.

8. The device of claim 1, wherein the coupling latches being made of a plastic material.

9. The device of claim 1, wherein the coupling latches being male coupling latches.

10. The device of claim 1, wherein the receiving latches being female coupling latches.

11. The device of claim 1, wherein the holes of the panel having a number being six (6).

12. The device of claim 1, wherein the panel being made of a rubber material.
